(19) United States
(12) Patent Application Publication
(10) Pub. No.: US 2013/0252110 A1
(43) Pub. Date: Sep. 26, 2013

(54) NEGATIVE ACTIVE MATERIAL AND LITHIUM BATTERY CONTAINING THE SAME

(71) Applicant: SAMSUNG SDI CO., LTD., Yongin-in (KR)

(72) Inventors: Sam-Jin PARK, Yongin-si (KR); Ki-Jun KIM, Yongin-si (KR); Na-Ri SEO, Yongin-si (KR); Ihn KIM, Yongin-si (KR); Dong-Ho SON, Yongin-si (KR); Myoung-Sun KIM, Yongin-si (KR); Young-Su KIM, Yongin-si (KR)

(73) Assignee: SAMSUNG SDI CO., LTD., Yongin-si (KR)

(21) Appl. No.: 13/759,312

(22) Filed: Feb. 5, 2013

(30) Foreign Application Priority Data
Mar. 20, 2012 (KR) 10-2012-0028413

(51) Int. Cl. H01M 4/36

(52) U.S. Cl. CPC H01M 4/364
USPC 429/231.8; 252/502

(57) ABSTRACT

A negative active material includes a silicon-based particle and a crystalline carbonaceous material, the crystalline carbonaceous material including a graphite particle and a carbonaceous nano-sheet.

### CROSS-REFERENCE TO RELATED APPLICATION

This application claims priority under 35 U.S.C. §119 to Korean Patent Application No. 10-2012-0028413, filed in the Korean Intellectual Property Office on Mar. 20, 2012, the disclosure of which is incorporated herein in its entirety by reference.

### BACKGROUND

1. Field

One or more embodiments relate to a negative active material and a lithium battery containing the negative active material.

2. Description of the Related Art

Lithium secondary batteries used in portable electronic devices for information communication, such as PDAs, mobile phones, notebook computers, and the like, electric bicycles, and electric vehicles exhibit a discharge voltage that is at least twice that of general batteries. Thus, lithium secondary batteries may have a high energy density.

Lithium secondary batteries include a positive electrode and a negative electrode that include active materials that allow the intercalation and deintercalation of lithium ions, and an organic electrolyte or a polymer electrolyte interposed therebetween. Such lithium secondary batteries generate electric energy according to an oxidation/reduction reaction occurring when lithium ions are intercalated/deintercalated in the positive and negative electrodes.

Positive active materials of lithium secondary batteries may be oxides of lithium and a transition metal that allows intercalation of lithium ions, such as a lithium cobalt oxide (LiCoO₂), a lithium nickel oxide (LiNiO₂), and a lithium nickel cobalt manganese oxide (e.g., Li[NiCoMn]O₂, Li[Ni_{1-x-y}CoₓM_{y}]O₂).

### SUMMARY

Embodiments are directed to a negative active material including a silicon-based particle and a crystalline carbonaceous material, the crystalline carbonaceous material including a graphite particle and a carbonaceous nano-sheet.

The silicon-based particle may include a material selected from Si, SiOₓ (where 0<x<2), Si—Z alloy (where Z is an alkali metal, alkali earth metal, a Group XIII element, a Group XIV element, a transition metal, a rare earth element, and combinations thereof and is not Si), and combinations thereof.

The silicon-based particle may have an average diameter in a range of about 1 μm to about 20 μm.

The graphite particle may include at least one of artificial graphite and natural graphite.

The graphite particle may have an average diameter in a range of about 0.1 μm to about 20 μm.

The carbonaceous nano-sheet may include a material selected from a polycyclic nano-sheet in which rings of carbon atoms fused to one another are arranged on a plane, a lamination of polycyclic nano-sheets, and combinations thereof.

The carbonaceous nano-sheet may have an average area in a range of about 0.0001 μm² to about 500 μm².

A thickness of the carbonaceous nano-sheet may be in a range of about 0.1 nm to about 100 nm.

An amount of the crystalline carbonaceous material may be in a range of about 0.1 to about 100 parts by weight based on 100 parts by weight of the silicon-based particle.

The graphite particle and the carbonaceous nano-sheet may be present at a weight ratio in a range of about 0.1:99.9 to about 99.9:0.1. The carbonaceous nano-sheet may have a sheet shape.

The silicon-based particle may be SiOₓ, where 0<x<2. The carbonaceous nano-sheet is a lamination of polycyclic nano-sheets having a structure in which 2 to 50 polycyclic nano-sheets are laminated.

Embodiments are also directed to a lithium battery including a negative electrode including the negative active material described above; a positive electrode facing the negative electrode and including a positive active material; and an electrolyte disposed between the negative electrode and the positive electrode.

### BRIEF DESCRIPTION OF THE DRAWINGS

Features will become apparent to those of skill in the art by describing in detail exemplary embodiments with reference to the attached drawings in which:

FIG. 1 illustrates a schematic diagram showing a structure of a negative active material according to an embodiment;

FIG. 2 illustrates a schematic diagram showing a structure of a lithium battery according to an embodiment;

FIGS. 3A and 3B illustrate scanning electron microscope (SEM) images of the negative electrode prepared in Example 1; and

FIG. 4 illustrates results of a capacity retention ratio measured according to the number of cycles of the coin cells of Examples 1 to 3 and Comparative Example 1.

### DETAILED DESCRIPTION

Example embodiments will now be described more fully hereinafter with reference to the accompanying drawings; however, they may be embodied in different forms and should not be construed as limited to the embodiments set forth herein. Rather, these embodiments are provided so that this disclosure will be thorough and complete, and will fully convey the scope of the invention to those skilled in the art.

In the drawing figures, the dimensions of layers and regions may be exaggerated for clarity of illustration. Like reference numerals refer to like elements throughout.

According to an embodiment, a negative active material includes a silicon-based particle and a crystalline carbonaceous material. The crystalline carbonaceous material includes a graphite particle and a carbonaceous nano-sheet.

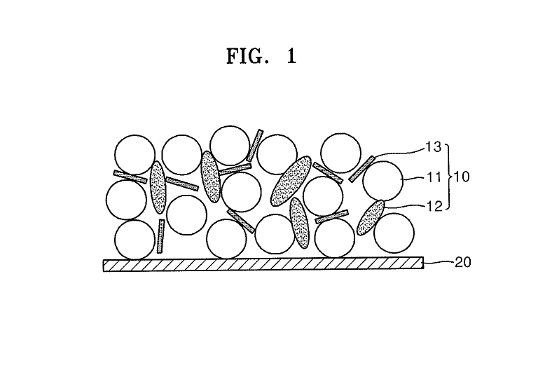

FIG. 1 is a schematic diagram illustrating a structure of a negative active material 10 according to an embodiment. Referring to FIG. 1, the negative active material 10 includes a silicon-based particle 11 and a crystalline carbonaceous material including a graphite particle 12 and a carbonaceous nano-sheet 13. The negative active material 10 may be coated on a substrate 20 such as, for example, a negative electrode current collector, and may form a negative electrode of a lithium battery.

The silicon-based particle 11 may have a high capacity as a negative active material. As examples, the silicon-based particle 11 may include a material selected from the group of Si, SiOₓ (where 0<x<2), Si—Z alloy (where Z is an alkali metal, alkali earth metal, a Group XIII element, a Group XIV element, a transition metal, a rare earth element, or combinations thereof, and is not Si), and combinations thereof. The element Z may be one selected from the group of Mg, Ca, Sr, Ba, Ra, Sc, Y, La, Ti, Zr, Hf, V, Nb, Ta, Cr, Mo, W, Tc, Re, Fe, Ru, Os, Co, Rh, Ir, Ni, Pd, Pt, Cu, Ag, Au, Zn, Cd, B, Ge, P, As, Sb, Bi, S, Se, Te, Po, and combinations thereof. Also, a silicon-based material such as Si, SiOx, Si—Z alloy, or the like, may include an amorphous silicon, a crystalline silicon (including monocrystalline silicon and polycrystalline silicon), or a mixture thereof, as examples. For the silicon-based particle 11, one of these materials listed above may be used alone, or a combination of at least two of these materials may be used. For example, a silicon oxide such as SiOₓ where 0<x<2, which may have a low expansion coefficient during charging and discharging, may be used as the silicon-based particle 11.

As an example, an average diameter of the silicon particle 11 may be in a micro size range considering the capacity per volume of a battery. Thus, an average diameter of the silicon-based particle 11 may be, for example, about 20 μm or less. For example, the silicon-based particle 11 may have an average diameter in a range of about 1 μm to about 20 μm, or, for example, in a range of about 1 μm to about 10 μm, or, for example, in a range of about 3 μm to about 7 μm. The silicon-based particle 11 having such a particle size may be obtained by micronizing a silicon-based material through a milling process, such as ball milling.

The crystalline carbonaceous material includes the graphite particle 12 and the carbonaceous nano-sheet 13.

The graphite particle 12 may serve as a bumper between the silicon-based particles 11. Accordingly, the graphite particle may inhibit a volumetric change of the silicon-based particle 11 during charging and discharging.

For the graphite particle 12, one or more of artificial graphite and natural graphite may be used. For the natural graphite, flake graphite, high crystalline graphite, or amorphous graphite (microcrystalline or cryptocrystalline) may be used, and for the artificial graphite, primary or electrographite, secondary graphite, or graphite fiber may be used. For the graphite particle 12, one kind of the graphite listed above may be used alone, or a combination of two or more kinds of the graphite may be used.

A crystal structure of the graphite particle 12 suitable for enabling reversible intercalation/deintercalation of lithium ions may be used. For example, in the graphite particle 12, an interlayer spacing (d002) of a (002) plane, as determined by X-ray diffraction, may be equal to or greater than about 0.333 nm and less than about 0.339 nm, or, for example, equal to or greater than about 0.335 nm and less than about 0.339 nm, or, for example, equal to or greater than 0.337 nm and equal to or less than 0.338 nm.

Also, a size of the graphite particle 12 may be substantially identical to a size of the silicon-based particle or smaller, considering mixture uniformity and improvement of mixture density. For example, an average diameter of the graphite particle 12 may be 20 μm or less, or, for example, in a range of about 0.1 μm to about 20 μm, or, for example, in a range about 0.1 μm to about 10 μm, or, for example, in a range of about 1 μm to about 10 μm, or, for example, in a range of about 1 μm to about 5 μm.

The carbonaceous nano-sheet 13 has a sheet shape. Accordingly, the carbonaceous nano-sheet 13 in the crystalline carbonaceous material may be differentiated from the graphite particle 12. The term “sheet shape” used herein may include a shape that is, based on 2-dimensional shape having a nanosize layer thickness, curved, curled, or partially deflected.

For example, the carbonaceous nano-sheet 13 may include a material selected from the group of a polycyclic nano-sheet in which rings of carbon atoms are polymerized to each other and arrayed on one plane, a lamination of the polycyclic nano-sheets, and combinations thereof. The polycyclic nano-sheet may be graphene. The lamination of the polycyclic nano-sheets may be, for example, a structure in which about 2 to about 50 polycyclic nano-sheets are laminated. For the carbonaceous nano-sheet 13, expanded graphite, which is obtained by intercalating chemicals such as acid or alkali into the interlayer of the lamination of the polycyclic nano-sheets and heating the resulting lamination to partially pre-inflate a vertical layer of molecular structures, may be used.

According to an embodiment, the carbonaceous nano-sheet 13 may have a thickness of about 100 nm or less. For example, a thickness of the carbonaceous nano-sheet 13 may be in a range of about 0.1 nm to about 100 nm, or, for example, in a range of about 0.1 nm to about 50 nm, or, for example, in a range of about 5 nm to about 20 nm. Also, an average surface area of the carbonaceous nano-sheet 13 may be, for example, in a range of about 0.0001 μm² to about 500 μm², or, for example, in a range of about 1 μm² to about 100 μm².

The carbonaceous nano-sheet 13 may have a large specific surface area and may be flexible, and thus, may cover much of the pores between the silicon-based particles 11 and the graphite particles 12. Also, the carbonaceous nano-sheet 13 may have better electrical conductivity than the graphite particle 12. Accordingly, a conductive path in the negative active material having the silicon-based material as a main component may be provided, thereby improving an electrical conductivity of the negative active material.

If the amount of the crystalline carbonaceous material is too large, a relative ratio of the amount of the silicon-based particle 11, which exhibits high capacity, to the amount of the crystalline carbonaceous material may decrease, resulting in reduced capacity. On the other hand, if the amount of the crystalline carbonaceous material is too small, the inhibiting effect thereof on volumetric expansion of the silicon-based particle 11 or its effect on improving an electrical conductivity of the negative active material may be insufficient. According to an embodiment, the amount of the crystalline carbonaceous material may be in a range of about 0.1 to about 100 parts by weight based on 100 parts by weight of the silicon-based particle 11, or, for example, in a range of about 0.1 to about 80 parts by weight, or, for example, in a range of about 1 to about 50 parts by weight, or, for example, in a range of about 1 to about 30 parts by weight, based on 100 parts by weight of the silicon-based particle 11.

If the amount of the graphite particle 12 in the crystalline carbonaceous material is relatively sufficient, an inhibiting effect thereof on volumetric expansion of the silicon-based particle 11 may be provided. If the amount of the carbonaceous nano-sheet 13 is relatively sufficient, a sufficient conductive path may be provided. The graphite particle 12 and the carbonaceous nano-sheet 13 may be contained at a weight ratio in a range of about 0.1:99.9 to about 99.9:0.1 or for example, in a range of about 1:99 to about 99:1, or, for example, in a range of about 10:90 to about 90:10, in parts by weight.

A lithium battery according to another embodiment includes a negative electrode including the negative active material described above, a positive electrode including a positive active material and facing the negative electrode, and an electrolyte interposed between the negative electrode and the positive electrode.

The negative electrode may include the negative active material described above. The negative electrode may be prepared by adding the negative active material described above, and a binder, to a solvent and mixing the solution to prepare a negative active material composition, and then forming the negative active material composition into a predetermined shape, or coating a current collector such as a copper foil with the negative active material composition. In an implementation, the negative electrode may be prepared by adding the negative active material described above, a binder, and a conductive material, to a solvent and mixing the solution to prepare a negative active material composition, and then forming the negative active material composition into a predetermined shape, or coating a current collector such as a copper foil with the negative active material composition.

The binder included in the negative active material composition may be a component assisting in binding the negative active material and the conductive material to each other, and assisting in binding the negative active material and the current collector to each other. The amount of the binder may be in the range of about 1 to about 50 parts by weight based on 100 parts by weight of the negative active material. Examples of the binder include polyvinylidene fluoride, polyvinyl alcohols, carboxymethylcellulose (CMC), starch, hydroxypropylcellulose, regenerated cellulose, polyvinylpyrrolidone, tetrafluoroethylene, polyethylene, polypropylene, ethylene-propylene-diene terpolymer (EPDM), sulfonated EPDM, styrene butadiene rubber, fluoro rubber, or various copolymers.

The negative active material described above includes carbonaceous nano-sheets that provide a conductive path. Accordingly, an additional conductive material may be omitted in the preparation of the negative active material. In other implementations, an additional conductive material may be selectively used to increase the electrical conductivity of the negative active material. The conductive material may be any suitable conductive material used in general lithium batteries. Examples of the conductive material may include carbonaceous materials such as carbon blacks, acetylene black, Ketjen black, and carbon fibers; metallic materials such as powders or fibers of metal such as copper, nickel, aluminum, and silver; conductive polymers such as polyphenylene derivatives, or mixtures thereof. The amount of the conductive material may be appropriately adjusted.

Examples of the solvent include N-methylpyrrolidone (NMP), acetone, water, or the like. The amount of the solvent may be in the range of about 1 to about 10 parts by weight based on 100 parts by weight of the negative active material. When the amount of the solvent is within this range, a process of forming a negative active material layer may be easily performed.

In addition, the current collector may be fabricated to have a thickness in the range of about 3 μm to about 500 μm. Any material having suitable conductivity and that does not cause chemical changes in the fabricated battery may be used. Examples of the current collector include copper, stainless steel, aluminum, nickel, titanium, sintered carbon, copper or stainless steel that is surface-treated with carbon, nickel, titanium or silver, or aluminum-cadmium alloys. In addition, the current collector may be processed to have fine irregularities on surfaces thereof so as to enhance the adhesive strength of the current collector to the negative active material. The current collector may be used in any of various forms including films, sheets, foils, nets, porous structures, foams, or non-woven fabrics.

The negative active material composition may be directly coated onto the current collector to manufacture a negative electrode plate. In other implementations, the negative electrode plate may be manufactured by casting the negative active material composition onto a separate support to form a negative active material film, separating the negative active material film from the support, and laminating the negative active material film on a copper foil current collector.

In other implementations, the negative electrode may be in other forms. For example, the negative active material composition may be printed on a flexible electrode substrate to manufacture a printable battery.

Separately, to fabricate the positive electrode, a positive active material, a conductive material, a binder, and a solvent may be mixed together to prepare a positive active material composition.

Any lithium-containing metal oxide that is commonly used in the art may be used as the positive active material. Examples of the lithium-containing metal oxide include LiCoO₂, LiMnₓO₂x, where x=1 or 2, LiNi₁₋ₓMnxO₂, where 0<x<1, or LiNi_{1-x-y}CoₓMn_{y}O₂, where 0≦x≦0.5 and 0≦y≦0.5. For example, compounds that allow the intercalation and deintercalation of lithium ions, such as LiMn₂O₄, LiCoO₂, LiNiO₂, LiFeO₂, V₂O₅, TiS, MoS, or the like may be used.

The conductive material, the binder, and the solvent used in the negative active material composition described above may also be used in the positive active material composition. If desired, a plasticizer may be added to each of the positive material composition and the negative material composition to form pores inside electrode plates thereof. In this regard, the amounts of the positive active material, the conductive material, the binder, and the solvent may be the same as those used in a general lithium battery.

The positive active material composition may be directly coated onto the positive electrode current collector and dried to prepare a positive electrode plate. In other implementations, the positive active material composition may be cast onto a separate support to form a positive active material film, and then, the positive active material film may be separated from the support and laminated on the positive electrode current collector to prepare the positive electrode plate.

The positive electrode and the negative electrode may be separated from each other by a separator. Any separator that is commonly used in lithium batteries may be used. In particular, the separator may have a low resistance to the migration of ions in an electrolyte and may have a high electrolyte-retaining ability. Examples of the separator may include glass fiber, polyester, Teflon, polyethylene, polypropylene, polytetrafluoroethylene (PTFE), or combinations thereof. Each of these may be a non-woven fabric or a woven fabric. The separator may have a pore diameter in the range of about 0.01 to about 10 μm, and a thickness in the range of about 5 to about 300 μm.

The electrolyte may be a lithium salt-containing non-aqueous electrolyte including a non-aqueous electrolyte and lithium. As the non-aqueous electrolyte, a non-aqueous electrolytic solution, an organic solid electrolyte, or an inorganic solid electrolyte may be used.

As the non-aqueous electrolytic solution, any of aprotic organic solvents such as N-methyl-2-pyrrolidone, propylene carbonate, ethylene carbonate, butylene carbonate, dimethyl carbonate, diethyl carbonate, gamma-butyrolactone, 1,2-dimethoxy ethane, tetrahydrofuran, 2-methyl tetrahydrofuran, dimethylsulfoxide, 1,3-dioxolane, formamide, dimethylformamide, acetonitrile, nitromethane, methyl formate, methyl acetate, phosphoric acid triester, trimethoxymethane, dioxolane derivatives, sulfolanes, methyl sulfolanes, 1,3-dimethyl-2-imidazolidinone, propylene carbonate derivatives, tetrahydrofuran derivatives, ethers, methyl propionate, or ethyl propionate may be used.

Examples of the organic solid electrolyte include polyethylene derivatives, polyethylene oxide derivatives, polypropylene oxide derivatives, phosphoric acid ester polymers, poly agitation lysine, polyester sulfide, polyvinyl alcohols, polyvinylidene fluoride, or polymers containing ionic dissociation groups.

Examples of the inorganic solid electrolyte include nitrides, halides and sulfates of lithium such as Li₃N, LiI, Li₅NI₂, Li₃N—LiI—LiOH, LiSiO₄, LiSiO₄—LiI—LiOH, Li₂SiS₃, Li₄SiO₄, Li₄SiO₄—LiI—LiOH, or Li₃PO₄—Li₂S—SiS₂.

The lithium salt may be any lithium salt that is commonly used in a lithium battery and that is soluble in the above-described lithium salt-containing non-aqueous electrolyte. For example, the lithium salt may include at least one selected from the group of LiCl, LiBr, LiI, LiClO₄, LiBF₄, LiB₁₀Cl₁₀, LiPF₆, LiCF₃SO₃, LiCF₃CO₂, LiAsF₆, LiSbF₆, LiAlCl₄, CH₃SO₃L₁, CF₃SO₃Li, (CF₃SO₂)₂NLi, lithium chloroborate, lower aliphatic carboxylic acid lithium, lithium tetraphenylborate, and imide.

Lithium batteries may be classified into lithium ion batteries, lithium ion polymer batteries, and lithium polymer batteries according to types of a separator and electrolyte used therein. In addition, lithium batteries may be classified into a cylindrical type, a rectangular type, a coin type, or a pouch type according to battery shape, and may also be classified into a bulk type or a thin film type according to battery size. Lithium batteries may be used either as primary lithium batteries or secondary lithium batteries.

The lithium battery may be manufactured by any suitable method.

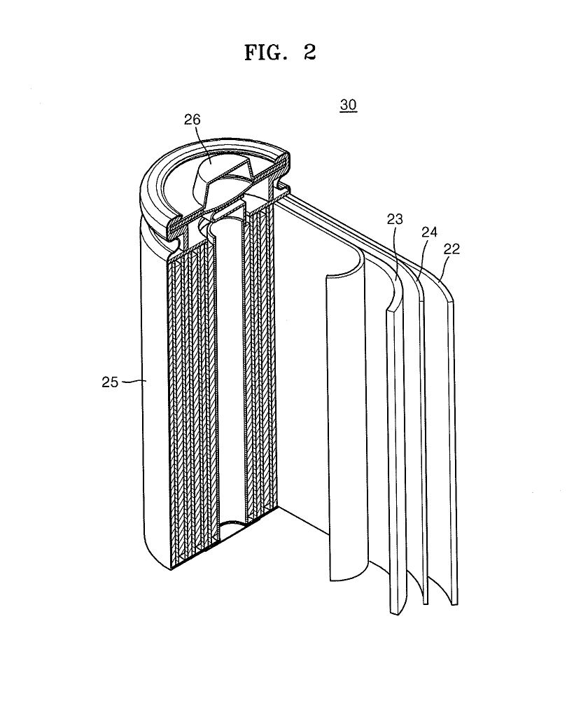

FIG. 2 is a schematic diagram illustrating a structure of a lithium battery 30 according to an embodiment.

Referring to FIG. 2, the lithium battery 30 may include a positive electrode 23, a negative electrode 22, and a separator 24 disposed between the positive electrode 23 and the negative electrode 22. The positive electrode 23, the negative electrode 22, and the separator 24 may be wound or folded, and then accommodated in a battery case 25. Subsequently, the electrolyte may be injected into the battery case 25, and the battery case 25 may be sealed by a sealing member 26, thereby completing the manufacture of the lithium battery 30. The battery case 25 may have a cylindrical shape, a rectangular shape, or a thin-film shape. The lithium battery 30 may be a lithium ion battery.

The lithium battery may be suitable for use as a power source for electric vehicles requiring a high capacity, a high-power output, and high temperature operability, in addition to a power source for general mobile phones and portable computers. The lithium battery may be coupled to existing internal combustion engines, fuel cells, or super-capacitors to be used in hybrid vehicles. In addition, the lithium battery may be used in other applications requiring a high-power output, a high voltage, and high temperature operability.

One or more embodiments will now be described more fully with reference to the following examples. However, these examples are provided only for illustrative purposes and are not intended to limit the scope of the one or more embodiments.

### Example 1

To prepare carbonaceous nano-sheets, first, 100 g of expanded graphite was heated at 500° C. for 1 hour. A gas generated therefrom was discharged through an exhaust of an oven. A resultant product obtained therefrom was dispersed in ethanol, and the dispersion was pulverized using a homogenizer at 10,000 rpm for 10 minutes. Then, a mixture obtained therefrom was further pulverized using a micro fluidizer. The pulverized mixture was filtered using a filtering device. The filtrate was washed with ethanol, and the washed filtrate was dried in an oven at 120° C. As a result, carbonaceous nano-sheets were obtained.

The obtained carbonaceous nano-sheets were added to water and a low-molecular weight polyacrylic acid (PAA) and mixed to prepare a solution. The solution was treated with a beads mill to prepare a dispersion. SiOₓ (manufactured by Shin-Etsu Chemical Co.) and artificial graphite (an artificial graphite called “MAG,” manufactured by Hitachi Chemical Co.) were measured and dispersed in the dispersion to prepare a final negative active material in which a weight ratio of the SiOₓ, the artificial graphite, and the obtained carbonaceous nano-sheets was 90:7:3.

The negative active material was mixed with a mixture of PAA and polyvinyl alcohol (PVA) (manufactured by Aldrich) as a binder at a weight ratio of 90:10, and, for adjustment of viscosity, water was added to the resultant mixture until the solid content in the mixture became 60 wt %, thereby preparing a negative active material slurry.

The negative active material slurry was then coated onto a copper foil current collector having a thickness of 10 μm to fabricate a negative electrode plate. Thereafter, the negative electrode plate was dried at 110° C. for 15 minutes and pressed to fabricate a negative electrode having a thickness of 60 μm. The fabricated negative electrode was dried in a vacuum at a temperature of 200° C. for 2 hours for binding the two binders, PAA and PVA. Next, the negative electrode was assembled with Li metal as a counter electrode, a polyethylene separator having a thickness of 20 μm (Product Name: STAR20, manufactured by Asahi), and an electrolyte to manufacture a 2016R-type coin half-cell. The electrolyte contained a mixed solvent including ethylene carbonate (EC), ethylmethyl carbonate (EMC), and diethyl carbonate (DEC) at a volume ratio of 3:3:4 and 1.10 M of LiPF₆.

### Example 2

A coin cell was manufactured in the same manner as in Example 1, except that a negative active material including SiOₓ, graphite, and carbonaceous nano-sheets at a weight ratio of 90:5:5 was used as a negative active material.

### Example 3

A coin cell was manufactured in the same manner as in Example 1, except that a negative active material including SiOₓ, graphite, and carbonaceous nano-sheets at a weight ratio of 90:3:7 was used as a negative active material.

### Comparative Example 1

A coin cell was manufactured in the same manner as in Example 1, except that a negative active material including SiOₓ, and artificial graphite at a weight ratio of 90:10 and not including carbonaceous nano-sheets was used as a negative active material.

### Evaluation Example 1

### Analysis of Scanning Electron Microscope (SEM) Image of Negative Electrode

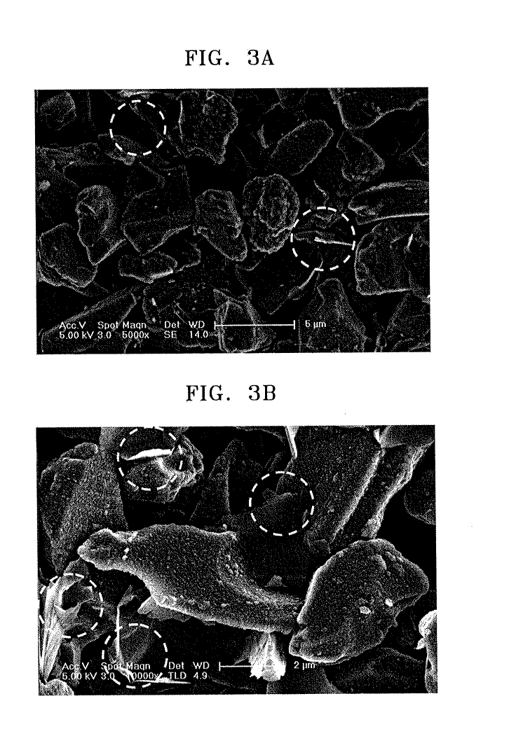

FIGS. 3A and 3B are scanning electron microscope (SEM) images of a surface of the negative electrode magnified and analyzed by using a SEM after fabricating the negative electrode in preparation processes of the coin cell of Example 1.

As shown in FIGS. 3A and 3B, the negative active material used in Example 1 may have the carbonaceous nano-sheets having a sheet shape between SiOₓ and graphite particles.

### Evaluation Example 1

### Evaluation of Lifetime Characteristics

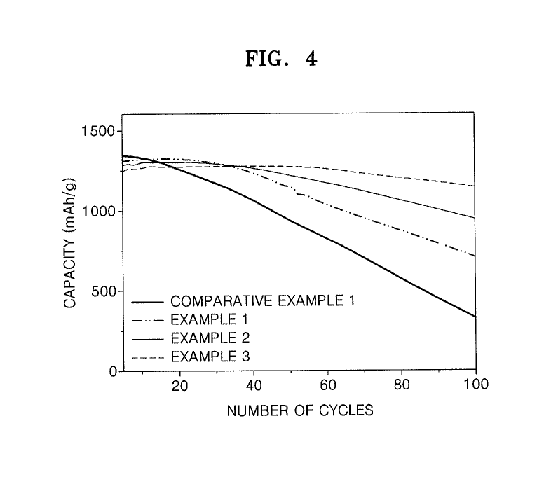

The coin cells manufactured according to Examples 1 to 3 and Comparative Example 1 were charged at a current of 10 to 20 mA per 1 g of the negative active material until the voltage thereof reached 0.001 V (with respect to Li), and then, were discharged at the same current until the voltage thereof reached 1.5 V (with respect to Li). Subsequently, the cycle of charging and discharging was repeated 100 times at the same current and the same voltage range. A capacity retention ratio of each coin cell according to the number of cycles was measured, and the measurement results are shown in FIG. 4.

As shown in FIG. 4, the coin cells of Examples 1 to 3 exhibited a longer lifetime at the 100th cycle than the coin cell of the Comparative Example. Also, it was confirmed that the lifetime characteristics were improved as the amount of the carbonaceous nano-sheets increased in the crystalline carbonaceous material.

By way of summation and review, negative active materials that allow the intercalation and deintercalation of lithium ions include various types of carbonaceous materials, including artificial and natural graphite and hard carbon, and non-carbonaceous materials such as Si, which may exhibit a very high capacity density that is at least ten times that of graphite. However, due to a volumetric expansion and contraction of a non-carbonaceous material during charging and discharging of a lithium battery, a lithium battery including such a non-carbonaceous negative active material may have a low capacity retention ratio, a low charge/discharge efficiency, and a decreased lifetime. Therefore, it is desirable to develop a high-performance negative active material with improved capacity and cycle lifetime characteristics.

As described above, the negative active material according to the one or more of the above embodiments may help to reduce an irreversible capacity loss due to a volumetric expansion and contraction of a non-carbonaceous material during charging and discharging of a lithium battery and may help to improve cycle lifetime characteristics of the lithium battery.

Example embodiments have been disclosed herein, and although specific terms are employed, they are used and are to be interpreted in a generic and descriptive sense only and not for purpose of limitation. In some instances, as would be apparent to one of ordinary skill in the art as of the filing of the present application, features, characteristics, and/or elements described in connection with a particular embodiment may be used singly or in combination with features, characteristics, and/or elements described in connection with other embodiments unless otherwise specifically indicated. Accordingly, it will be understood by those of skill in the art that various changes in form and details may be made without departing from the spirit and scope as set forth in the following claims.

What is claimed is:

1. A negative active material, comprising:
a silicon-based particle; and
a crystalline carbonaceous material, the crystalline carbonaceous material including a graphite particle and a carbonaceous nano-sheet.

2. The negative active material as claimed in claim 1, wherein the silicon-based particle includes a material selected from Si, SiOₓ, where 0<x<2, a Si—Z alloy, and a combination thereof, where Z is an alkali metal, an alkali earth metal, a Group XIII element, a Group XIV element, a transition metal, a rare earth element, or a combination thereof, and Z is not Si.

3. The negative active material as claimed in claim 1, wherein the silicon-based particle has an average diameter in a range of about 1 μm to about 20 μm.

4. The negative active material as claimed in claim 1, wherein the graphite particle includes at least one of artificial graphite and natural graphite.

5. The negative active material as claimed in claim 1, wherein the graphite particle has an average diameter in a range of about 0.1 μm to about 20 μm.

6. The negative active material as claimed in claim 1, wherein the carbonaceous nano-sheet includes a material selected from a polycyclic nano-sheet in which rings of carbon atoms fused to one another are arranged on a plane, a lamination of polycyclic nano-sheets, and combinations thereof.

7. The negative active material as claimed in claim 1, wherein the carbonaceous nano-sheet has an average area in a range of about 0.0001 μm² to about 500 μm².

8. The negative active material as claimed in claim 1, wherein a thickness of the carbonaceous nano-sheet is in a range of about 0.1 nm to about 100 nm.

9. The negative active material as claimed in claim 1, wherein an amount of the crystalline carbonaceous material is in a range of about 0.1 to about 100 parts by weight based on 100 parts by weight of the silicon-based particle.

10. The negative active material as claimed in claim 1, wherein the graphite particle and the carbonaceous nano-sheet are present at a weight ratio in a range of about 0.1:99.9 to about 99.9:0.1.

11. The negative active material as claimed in claim 1, wherein the carbonaceous nano-sheet has a sheet shape.

12. The negative active material as claimed in claim 1, wherein:
the silicon-based particle is SiOₓ, where 0<x<2, and
the carbonaceous nano-sheet is a lamination of polycyclic nano-sheets having a structure in which 2 to 50 polycyclic nano-sheets are laminated.

13. A lithium battery, comprising:
a negative electrode including the negative active material according to claim 1;
a positive electrode facing the negative electrode and including a positive active material; and
an electrolyte disposed between the negative electrode and the positive electrode.
